(19) United States
(12) Patent Application Publication
(10) Pub. No.: US 2011/0077561 A1
(43) Pub. Date: Mar. 31, 2011

(54) APPARATUS TO PROVIDE USER-GUIDED BACK MASSAGE FOR SPECIFIC AREA RELIEF THROUGH MUSCLE AND CONNECTIVE TISSUE MASSAGE ACTION

(76) Inventor: Michael Choly, West Bloomfield, MI (US)

(21) Appl. No.: 12/569,441

(22) Filed: Sep. 29, 2009

(51) Int. Cl. A61H 1/00; A61H 15/00; G06F 3/041

(52) U.S. Cl. 601/15; 601/112; 345/173

(57) ABSTRACT

A user-guided massage unit, including a housing having a three-dimensional massage mechanism for massaging in three-dimensions, the three-dimensional massage mechanism being in electronic contact with a touch-screen interface and including a translation mechanism for translating movement on the touch-screen interface to movement of the three-dimensional massage mechanism. A chair including the user-guided massage unit. A method of providing a massage by operating a touch-screen interface, translating movement on the touch-screen interface to movement of a three-dimensional massage mechanism of a user-guided massage unit, moving the three-dimensional massage mechanism, and providing a massage. A method of storing a massage routine by selecting a learning mode, operating a touch-screen interface, translating movement on the touch-screen interface to movement of a three-dimensional massage mechanism of a user-guided massage unit, moving the three-dimensional massage mechanism, providing a massage, and storing the massage routine.

### BACKGROUND OF THE INVENTION

(1) Field of the Invention

The present invention relates to massage units. In particular, the present invention relates to user-operated massage units.

(2) Description of related art

Many massage devices have been developed that are stand-alone units or are integrated into a chair. Some provide user-control that can adjust the pressure of the massage, as well as the position. Furthermore, programmed massage routines can be performed with these devices.

U.S. Patent Application Publication No. 2006/0190057 to Reese discloses a device for treating lower back pain with transcutaneous electrical nerve stimulation that provides a massage-like effect. A stimulation pad 110 is placed on the patient's lower back. A controller 140 is used by the patient to select pre-programmed stimulation routines and it can also be used in a manual mode, which can be saved as a routine. The controller can include an electronic touch pad 147, wherein the touch pad presents a scaled correspondence with the patterned array of electrodes within the stimulation pad 110 as shown with grid lines. By touching at least one grid, the electrodes will be energized or de-energized at the corresponding point on the stimulation pad.

U.S. Patent Application Publication No. 2008/0039751 to Yang discloses a massaging apparatus 2 that has a massage member movable in transverse, longitudinal, and vertical directions by drive units. The massage member is mounted to a main frame 32 above a bed 3 in which a patient rests. A control unit 8 controls each drive unit to move the massage member to contact the patient's body at a desired acupuncture point. The user of the Yang device does not have control at any time of the position of the massage member, but rather the position is programmed.

While these massage devices provide some level of user control, they are lacking full control by the user. Most devices do not provide control of position, speed, or pressure of the massage applicator. Furthermore, there is not an accurate method of controlling the position of the massage device according to where a user would prefer to be massaged. Current massage devices do not accommodate physiological dimensional diversity between females and males. Therefore, there is a need for a device that can overcome these limitations.

### BRIEF SUMMARY OF THE INVENTION

The present invention provides for a user-guided massage unit, including a housing having a three-dimensional massage mechanism for massaging in three-dimensions, the three-dimensional massage mechanism being in electronic contact with a touch-screen interface and including a translation mechanism for translating movement on the touch-screen interface to movement of the three-dimensional massage mechanism.

The present invention also provides for a chair including the user-guided massage unit.

The present invention provides for a method of providing a massage by operating a touch-screen interface, translating movement on the touch-screen interface to movement of a three-dimensional massage mechanism of a user-guided massage unit, moving the three-dimensional massage mechanism, and providing a massage.

The present invention further provides for a method of storing a massage routine by selecting a learning mode, operating a touch-screen interface, translating movement on the touch-screen interface to movement of a three-dimensional massage mechanism of a user-guided massage unit, moving the three-dimensional massage mechanism, providing a massage, and storing the massage routine.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 is a perspective view of the inside of the housing of the user-guided massage unit;

FIGS. 2A-2C are perspective views of the housing;

FIG. 3 is a perspective view of the housing with the stylus shown in dotted lines under the membrane and touch-screen interface, showing electronic signals being sent from the touch-screen interface to the housing;

FIG. 4 is a flowchart showing the flow of electronic signals in the present invention;

FIG. 5 is a cut-out view of the user-guided massage unit in a chair;

FIGS. 6A-6C show various views of the touch-screen interface with different types of operating controls;

FIG. 7 is a perspective view of the inside of the housing of the user-guided massage unit showing the stylus housing and stylus;

FIG. 8 is perspective view of the inside of the housing of the user-guided massage unit showing the stylus housing;

FIG. 9 is an up-close perspective view of the stylus housing;

FIG. 10 is a top view of the inside of the housing of the user-guided massage unit;

FIG. 11 is a top view of the inside of the housing of the user-guided massage unit;

FIG. 12 is a side view of the user-guided massage unit;

FIG. 13 is a side view of the user-guided massage unit;

FIG. 14 is a perspective view of a touch-screen interface; and

FIG. 15 is a top view of the inside of the housing of the user-guided massage unit showing the stylus housing and stylus.

### DETAILED DESCRIPTION OF THE INVENTION

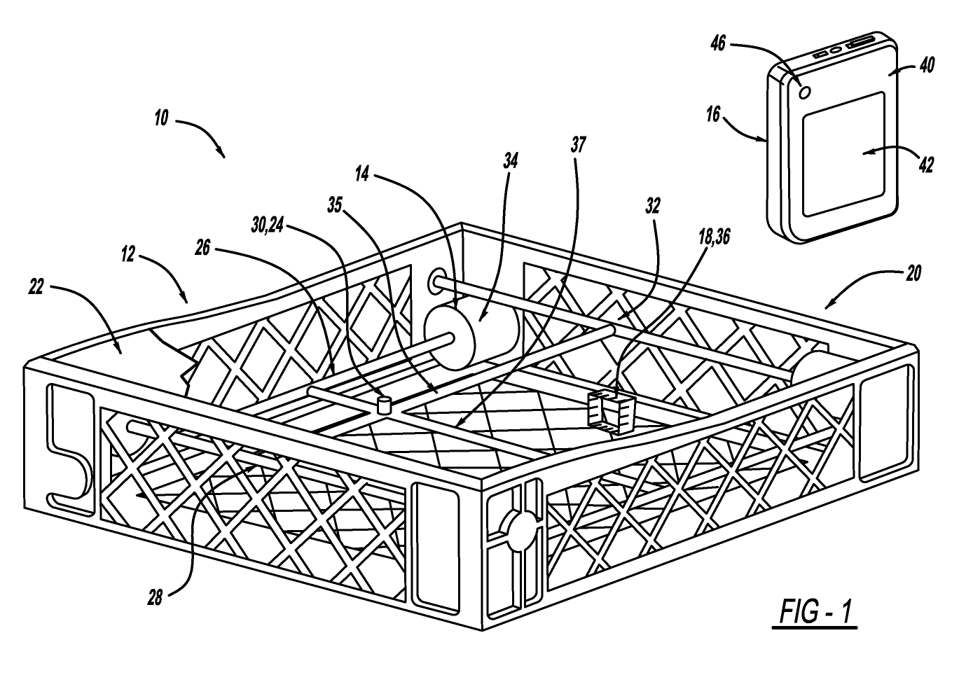

The present invention is directed to a user-guided massage unit 10, shown generally in FIG. 1. The user-guided massage unit 10 includes a housing 12 having a three-dimensional massage mechanism 14 for massaging a user in three-dimensions, the three-dimensional massage mechanism 14 being in electronic contact with a touch-screen interface 16 and including a translation mechanism 18 for translating movement on the touch-screen interface 16 to movement of the three-dimensional massage mechanism 14.

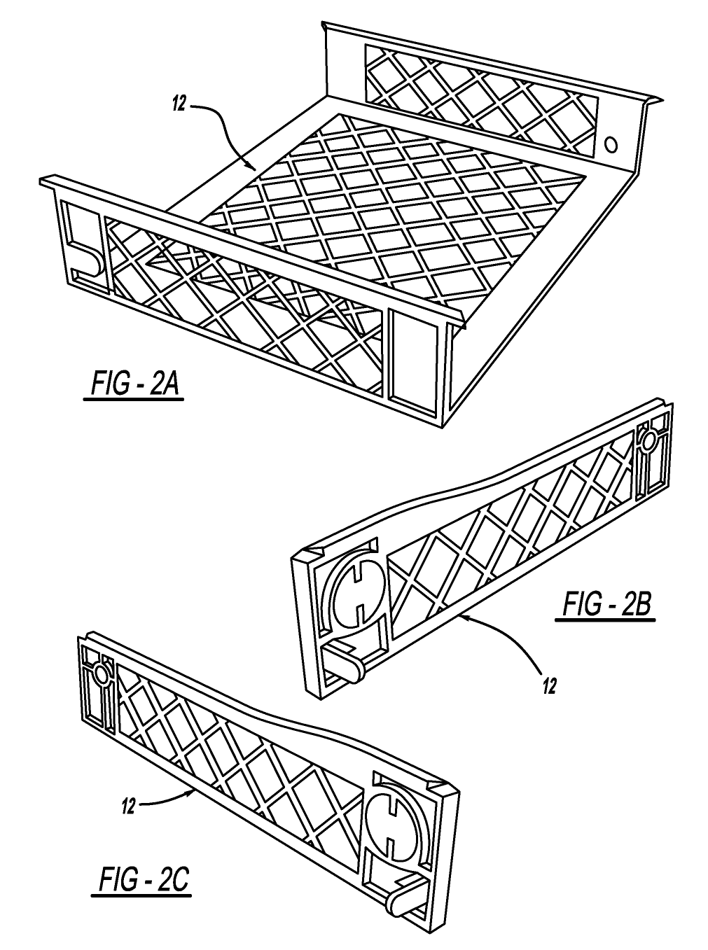

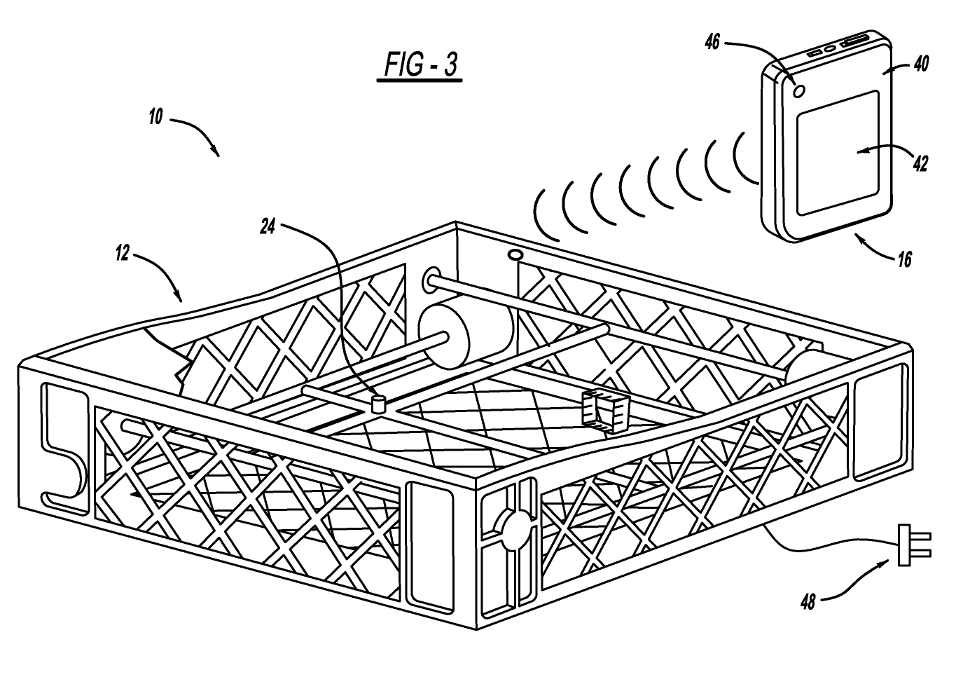

The housing 12 is made of appropriate material to protect the three-dimensional massage mechanism 14 and all related circuitry, and can be made of composite parts as shown in FIGS. 2A-2C. Preferably, a top side 20 of the housing 12 is made of a membrane surface 22, as shown in FIG. 3. The membrane surface 22 is flexible enough to accommodate the movement of three-dimensional massage mechanism 14 underneath while providing protection from outside elements thereto. In other words, the three-dimensional massage mechanism 14 contacts the membrane surface 22 from underneath to provide a massage to a user who is also contacting the membrane surface 22 from the outside. The membrane surface 22 is made out of any suitable membrane material, for example nylon or spandex. The housing 12 can be any size, and can be made in a variety of sizes depending upon the type of massage to be performed. For example, a larger size can be used for a back massage in a square shape, whereas a smaller size in a rectangular shape can be used for a leg massage. One specific size that can be used is a 30″ square. The housing 12 can also be surrounded by foam padding for comfort of the user.

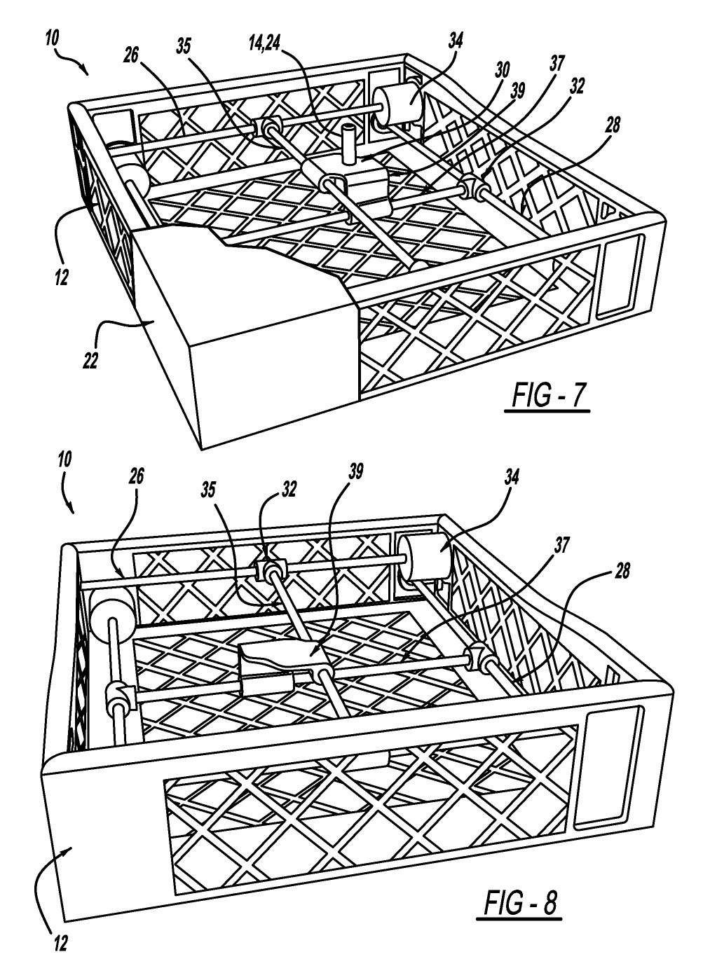

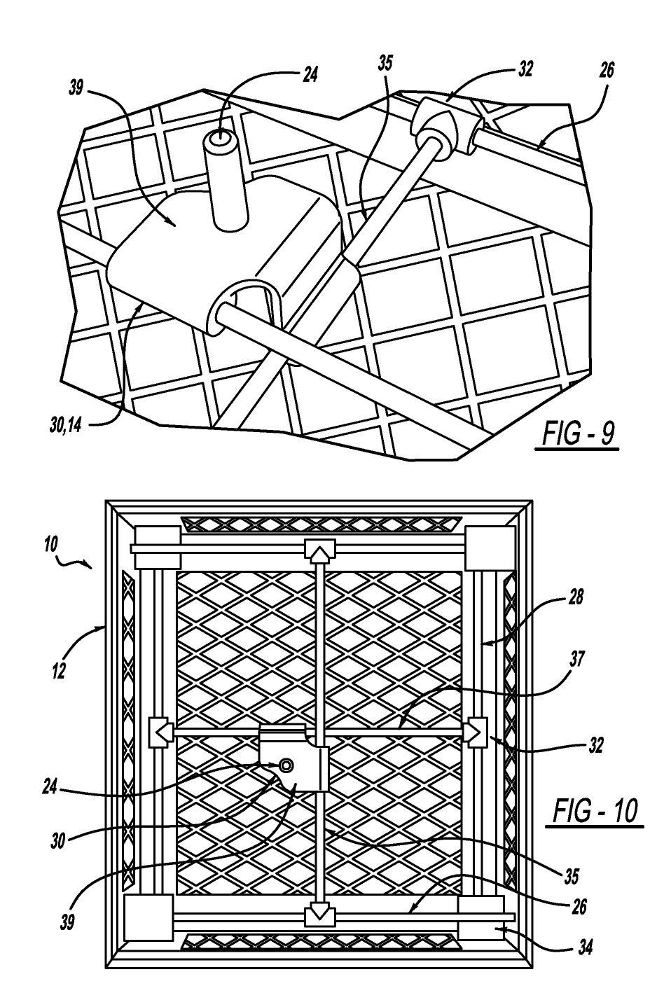

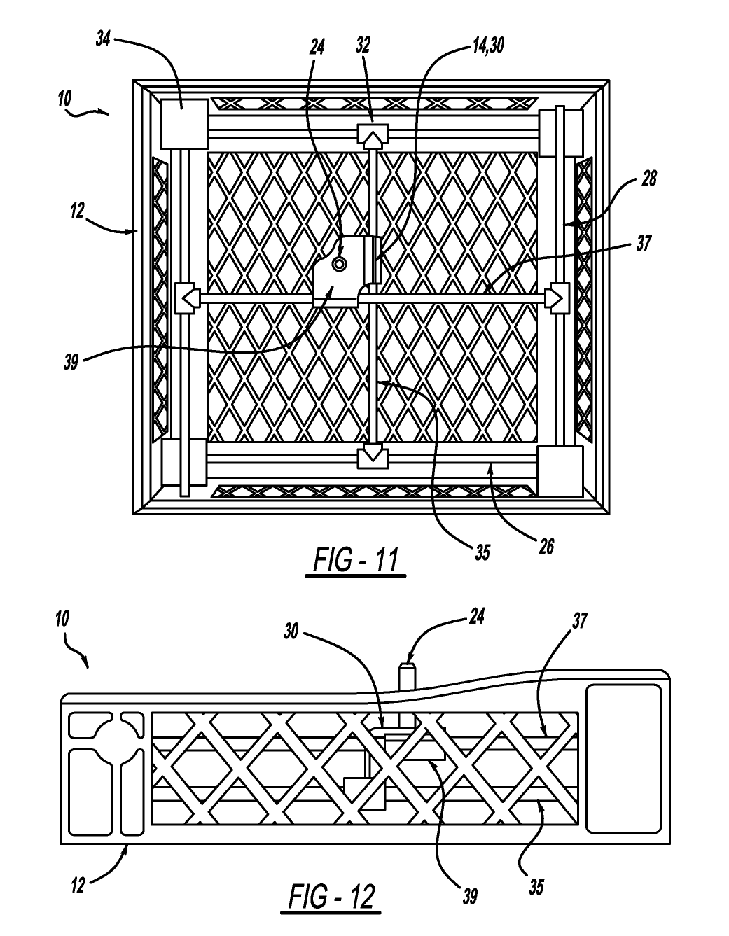

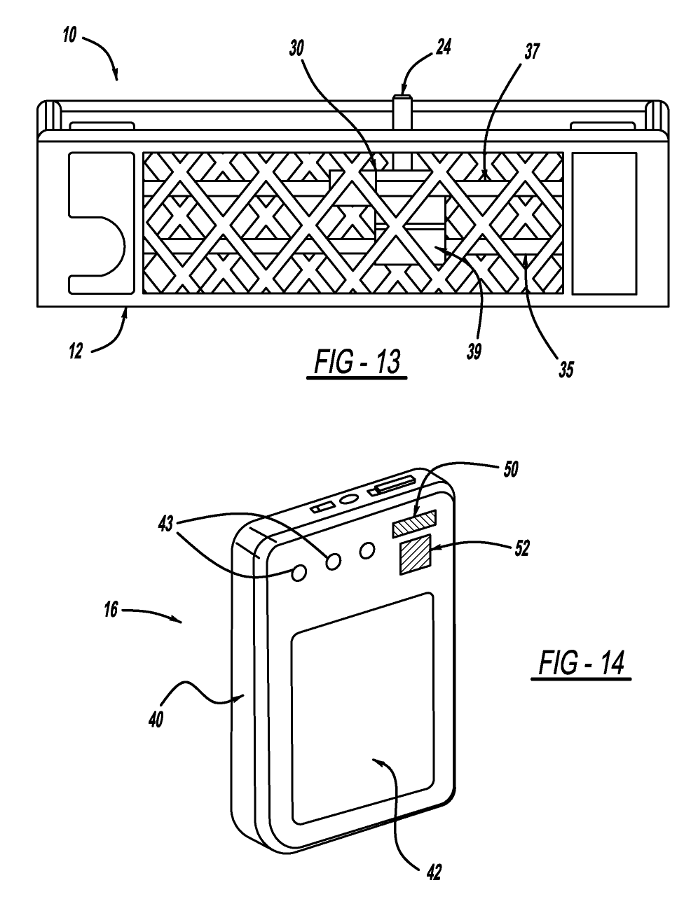

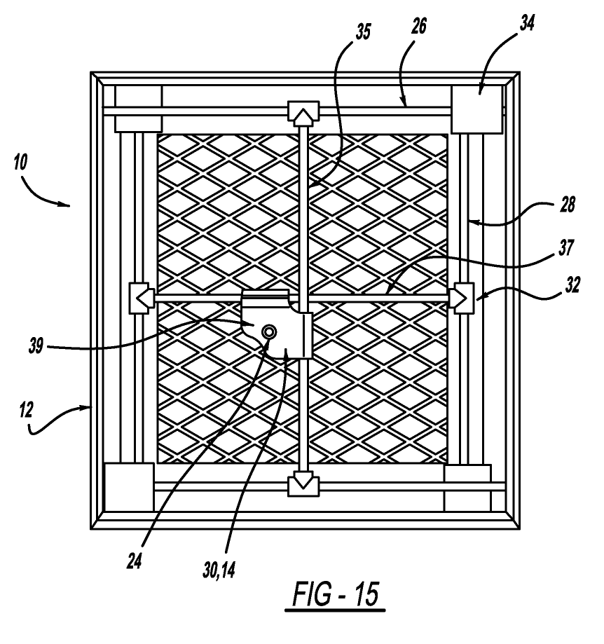

The three-dimensional massage mechanism 14 is further defined as a stylus 24 operatively connected to an x-axis movement mechanism 26, a y-axis movement mechanism 28, and a z-axis movement mechanism 30. The stylus 24 contacts the membrane surface 22 and provides the massage to the user. The stylus 24 can be in any shape that is able to provide a massage, such as, but not limited to, a cylinder or a cylinder with a rounded top. The stylus 24 can include a separate housing 39 that operatively connects to the x-, y-, and z-axis movement mechanisms 26, 28, 30, as shown in FIGS. 7-13 and 15, with a close-up view in FIG. 9. Alternatively, the stylus itself includes structure for connection. The stylus 24 is freely moveable along any of the axes.

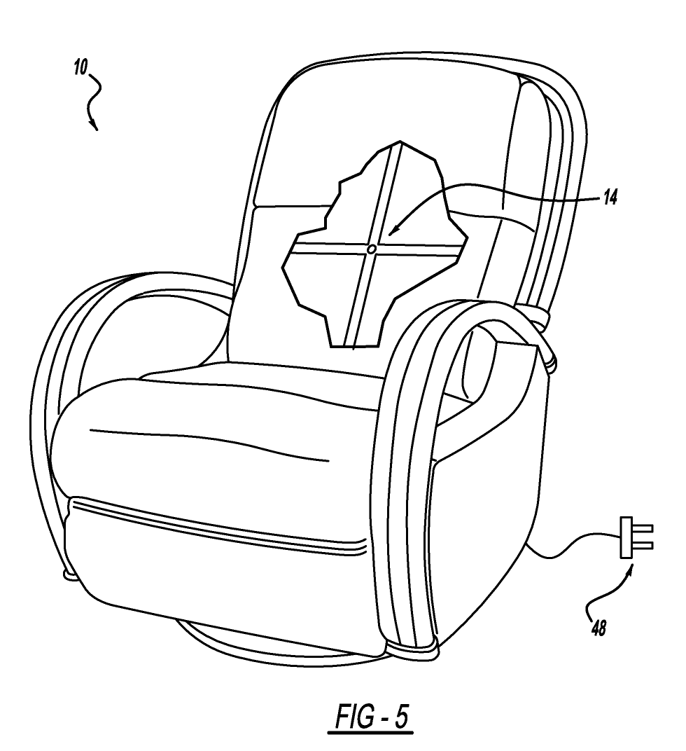

The x-, y-, and z-movement mechanisms 26, 28, 30 allow the stylus 24 to be moved in any direction in the x-, y-, and z-axes of the housing 12 according to the user's input on the touch-screen interface 16, thus providing a massage in three-dimensions. The x- and y-axis movement mechanisms 26, 28 move the stylus 24 to any position along the length and width of the housing 12 (i.e. anywhere in the horizontal plane when the user-guided massage unit 10 is laying flat as in FIG. 1, when the user-guided back massage 10 is for example in the back of a chair, this would be anywhere in the vertical plane as in FIG. 5). The z-axis movement mechanism moves the stylus 24 to desired depth of the housing 12 (i.e. up or down when the user-guided massage unit 10 is laying flat as in FIG. 1, when the user-guided back massage 10 is in the back of a chair, this would be inwards and outwards as in FIG. 5).

A linear motion mechanism 36 translates rotary motion of motors 34 to linear motion of the x- and y-axis movement mechanisms 26, 28. More specifically, the x- and y-axis movement mechanisms 26, 28 are each made of carriages 32 driven by motors 34 along the appropriate axis. For example, two motors and worm gears can be used to drive each of the x- and y-axis movement mechanisms 26, 28. A right-hand and left-hand threaded carriage 32 is used for vertical movement along the y-axis (see a close-up view in FIG. 9). A right-hand and left-hand threaded carriage 32 is also used for horizontal movement along the x-axis. The threaded carriage 32 is preferably t-shaped, although other shapes can also be used. The stylus 24 is contained in the housing 39 and is slidably connected to both a carrier beam 35 for horizontal movement along the x-axis and a carrier beam 37 for vertical movement along the y-axis. The carrier beams 35, 37 are each slidably connected at a proximal and distal end to the threaded carriages 32. Thus, motors 34 drive the two threaded carriages 32 for x-axis movement which in turn moves the carrier beam 35, and motors 34 drive the two threaded carriages 32 for y-axis movement which in turn moves the carrier beam 37. The carrier beams 35, 37 are also slidably connected to each other through the stylus housing 39. The z-axis movement mechanism 30 is also driven by a motor 34 on the stylus housing 39 in order to change the pressure exerted by the stylus 24 on the user in the z-axis. The connections between the carrier beams 35, 37 and the threaded carriages 32 as well as the stylus housing 39 are shown in FIGS. 7-13 and 15.

The x-, y-, and z-axis movement mechanisms are in electronic communication with the translation mechanism 18, and thus include any necessary circuitry and electronics for receiving data that instructs their movement. The three-dimensional massage mechanism 14 can also include any necessary friction reduction mechanisms on any of the parts described above.

The three-dimensional massage mechanism 14 can further include various elements that enhance the massage, such as, but not limited to, a pulsing element, a heating element, or combinations thereof. These elements are in electronic connection with the translation mechanism 18 for receiving signals from the touch-screen interface 16 and can be turned on and off and adjusted as desired from the touch-screen interface 16.

The translation mechanism 18 preferably includes an algorithm for translating movement on the touch-screen interface 16 to movement of the three-dimensional massage mechanism 14, or, more specifically, the x-, y-, and z-axis movement mechanisms 26, 28, 30. One skilled in the art can determine an appropriate algorithm to use. Any necessary circuitry and/or hardware are included to run the program. The translation mechanism 18 also includes an electronic receiving mechanism 38 for receiving electronic signals sent from the touch-screen interface 16. The signals received can be wireless or hardwire signals. Wireless signals can be any electromagnetic waves, such as radio frequency (RF) or infrared (IR), and can use Wi-Fi or Bluetooth. Any other wireless technology can also be used.

The housing 12 also includes a power source 48 that supplies power to all components requiring power. The power source 48 can be a battery, AC power, or DC power. Combinations thereof can also be used.

When the user-guided massage unit 10 is a stand-alone unit, the housing 12 can include various attachment mechanisms in order to attach the unit 10 to a chair, a bed, the floor, or wherever a user desires the unit 10 to be placed in order to provide a massage. Attachment mechanisms can include hook-and-loop fasteners, straps, hooks, clasps, or any other suitable mechanism.

The touch-screen interface 16 is operated by the user to send signals to the user-guided massage unit 10 in order to provide a massage. More specifically, the touch-screen interface 16 includes a console 40 that houses a touch-screen 42. The console 40 is made of a material such as plastic. The touch-screen 42 is any suitable screen that responds to a user's touch of their fingertips and can detect the pressure of a touch, for example, a screen that includes sensor cells that are activated by touch. Preferably, the size of the touch-screen corresponds to the area of operability of the three-dimensional massage mechanism 14. In other words, any part of the touch-screen 42 corresponds to an area in which the three-dimensional massage mechanism 14 is able to provide a massage. Alternatively, only a portion of the area of the touch-screen 42 corresponds to an area of operability of the three-dimensional massage mechanism 14, whereas another portion of the touch-screen 42 can include various controls or buttons, further described below. Essentially, where the user touches their fingertip to the touch-screen 42, a corresponding area in the housing 12 provides a massage by the three-dimensional massage mechanism 14.

The touch-screen interface 16 also includes a data conversion mechanism 44 for converting movement on the touch-screen interface 16 into data. Any necessary circuitry, processors, and electronics are also provided in order to convert the movement into data.

The touch-screen interface 16 includes an electronic transmitting mechanism 46 for transmitting electronic signals to the electronic receiving mechanism 38 of the housing 12, as shown in FIG. 3. In other words, once the movement on the touch-screen interface 16 is converted into data, the electronic transmitting mechanism 46 transmits this data to the electronic receiving mechanism 38 so that the three-dimensional massage mechanism 14 can be moved in the desired direction. The signals received can be wireless or hardwire signals. Wireless signals can be any electromagnetic waves, such as radio frequency (RF) or infrared (IR), and can use Wi-Fi or Bluetooth. Any other wireless technology can also be used.

The touch-screen interface 16 further includes a power source 48 such as, but not limited to, batteries, hardwire power from the housing 12, solar power by use of solar cells, and combinations thereof. An indication light can be included to show that power is on or off for the housing 12 and touch-screen interface 16.

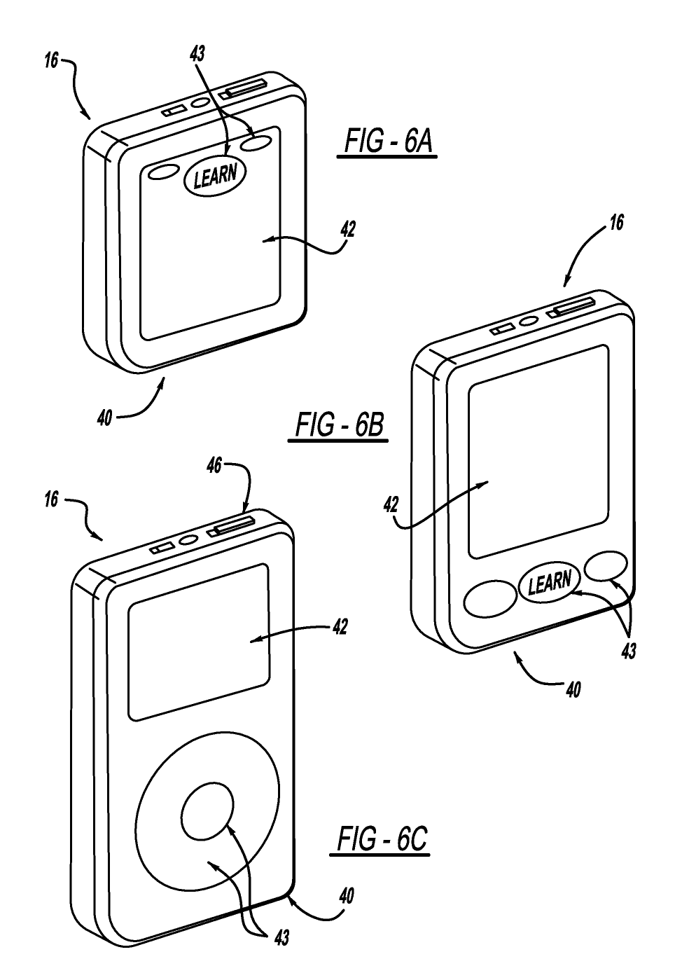

The touch-screen interface 16 can also include operating controls 43, as shown in FIGS. 6A-6C, for elements such as, but not limited to, a pulsing element, a heating element, or combinations thereof as described above. The operating controls 43 can also be used to set, save, and/or select a massage routine to be performed. The operating controls 43 can be, but are not limited to, touch-screen controls (FIG. 6A), hard controls (FIG. 6B), click wheel controls (FIG. 6C), and voice controls with the use of a speaker 50 and microphone 52 (FIG. 14) built into the touch-screen interface 16. When the operating controls 43 are touch-screen controls, an area of the touch-screen 42 can be designated for such controls. Alternatively, the controls can be hidden from view and brought up by the user by placing their fingertips over a certain area of the touch-screen 42. When the operating controls are hard controls, such as buttons or levers, each one is labeled for quick identification by the user on the touch-screen interface 16.

Preferably, the touch-screen interface 16 includes memory to be used for storing and selecting massage routines. These routines can be pre-set in the touch-screen interface 16 or they can be programmed by the user by using a “learn” mode. The memory can store combinations of a massage routine with the various other options such as pulsing and heat as well. Other modes can be selected, such as repetitions of the routines, shuffling routines, and run-time length. The memory can be on-board RAM, flash memory, EPROM, or any other digital memory. The touch-screen interface 16 can also include various menus to select a certain massage routine, which can be hard controls, touch-screen menus, and voice controls.

The user-guided massage unit 10 can optionally be integrated into a piece of furniture, such as a chair, a bed, or any other suitable furniture. For example, the user-guided massage unit 10 can be incorporated into the back of an armchair or the back of an airplane seat.

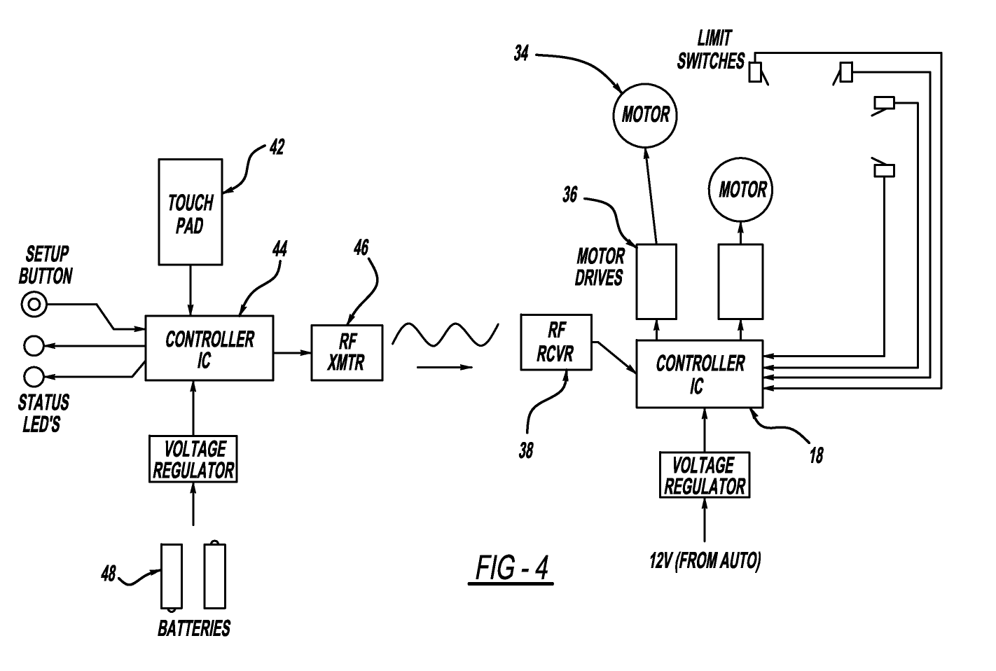

The present invention provides for a method of providing a massage, including the steps of operating the touch-screen interface 16, translating movement on the touch-screen interface 16 to movement of the three-dimensional massage mechanism 14 of the user-guided massage unit 10, moving the three-dimensional massage mechanism 14, and providing a massage. A flow chart in FIG. 4 shows generally how electronic signals are sent in the method.

The user operates the touch-screen interface 16 by moving their fingertip across the touch-screen 42 in the direction that the massage is desired. The massage provided by the three-dimensional massage mechanism 14 follows the path of the user's fingertip on the touch-screen 42. In other words, movement of the user's fingertip across the touch-screen 42 is translated to movement of the stylus 24 in the x-, y-, and z-axes in the user-guided massage unit 10. More specifically, movement of the user's fingertip across the touch-screen 42 corresponds to movement of the stylus 24 in the x- and y-axes. The pressure applied to the touch-screen 42 corresponds to the movement of the stylus 24 in the z-axis, i.e. the more pressure that is applied to the touch-screen 42, the more pressure is used by the stylus 24 by moving out of the housing 12. Pressure can be generated on the touch-screen 42 by the amount of sensor cells on the touch-screen that are activated. Light pressure activates only some sensor cells, whereas harder pressure activates a larger (cluster-area) of sensor cells. The varying area of activated sensor cells can be detected by the circuitry and translated into a direction on the z-axis.

Translation of the movement on the touch-screen interface 16 to movement of the three-dimensional massage mechanism 14 occurs as follows. Essentially, data is received from the touch-screen interface 16 and is translated into movement of the three-dimensional massage mechanism 14. First, the data conversion mechanism 44 converts the movement on the touch-screen interface 16 by the user's fingertip into data. Next, the electronic transmitting mechanism 26 on the touch-screen interface 16 transmits the data to the electronic receiving mechanism 38 on the housing 12. The electronic receiving mechanism 38 sends this data to the translation mechanism 18 which uses an algorithm to translate the movement on the touch-screen 42 to movement of the three-dimensional massage mechanism 14, or, more specifically, the x-, y-, and z-axis movement mechanisms 26, 28, 30.

Movement of the three-dimensional massage mechanism 14 occurs through the motors 34 that drive the carriages 32 on each of the x- and y-axis movement mechanisms 26, 28. The motors 34 can be standard stepper or servo motors that rotate a given angular amount and velocity based on a digital input signal from the translation mechanism 18. The motors 34 drive the carriages 32 and thus the stylus housing 39 along the carrier beams 35, 37 to the appropriate position along the x- and y-axes. The z-axis movement mechanism 30 is also driven by a motor 34. Thus, by the movement of the three-dimensional massage mechanism 14, the user is provided a massage.

The user can also select a various operating mode such as pulsing, heating, and combinations thereof as described above at any time during the massage. The user can also store a massage routine in the touch-screen interface 16 while operating the touch-screen interface 16 and this method is further described below. Alternatively, the operation of the touch-screen interface 16 can be accomplished by selecting a stored massage routine. In this case, the movement of the three-dimensional massage mechanism 14 is pre-programmed so the user does not need to move their fingertip across the touch-screen 42 to provide a massage, but rather the data is automatically sent when needed from the touch-screen interface 16 to the three-dimensional massage mechanism 14 to provide the massage. A particular massage routine can be selected from a touch-screen menu, hard buttons, or a voice command.

The present invention also provides for a method of storing a massage routine, including the steps of selecting a learning mode, operating the touch-screen interface 16, translating movement on the touch-screen interface 16 to movement of the three-dimensional massage mechanism 14 of the user-guided massage unit 10, moving the three-dimensional massage mechanism 14, providing a massage, and storing the massage routine.

The operating, translating, moving and providing steps of this method are the same as the method above. However, before beginning the massage by moving their fingertip across the touch-screen 42, the user selects a learning mode on the touch-screen interface 16. The learning mode can be selected by pressing a hard control, a touch-screen control, or by speaking a command that is recognized by a voice control. Once the learning mode is selected, operation of the user-guided massage unit 10 continues as described above. The user performs a desired massage, and once the massage is over, it can be stored in the memory of the touch-screen interface 16. In order to store the massage routine, the user can press a stop control or depress the learn control. The user can also give the massage routine a name or store it under a certain number so that it can be recalled and the massage routine performed.

The present invention can be used in many different situations or for many different indications. The user-guided massage unit 10 can be used for relaxation and relief of muscle tension, minor back pain, and insomnia. In health care or medical applications, the user-guided massage unit 10 can be used by immobilized patients to improve and stimulate blood-flow and circulation as well as stimulate nerve activity. Appropriate massage routines can also be programmed for each of these applications depending on the user's/patient's need.

The invention is further described in detail by reference to the following experimental examples. These examples are provided for the purpose of illustration only, and are not intended to be limiting unless otherwise specified. Thus, the present invention should in no way be construed as being limited to the following examples, but rather, be construed to encompass any and all variations which become evident as a result of the teaching provided herein.

### Example 1

The following parts were used to create the user-guided massage unit of the present invention in TABLES 1 and 2. These are only one example of parts that can be used, and one skilled in the art can substitute similar parts.

TABLE 1

| Sorting | | | | | |
|---|---|---|---|---|---|
| Index # | Ref | Description | Alts | Qty | UM |
| 1 | | | | | |
| 2 | Items to ship with PCBA | | | | |
| 3 | | MOTOR, 120 VDC 16 W | N | 5 | EA |
| 4 | | | | | |
| 5 | PCBA | | | | |
| 6 | | PCB, 2-LAYER APPROX 7 × 11 IN. | Y | 1 | EA |
| 7 | RF Receiver (ASK/OOK) | | | | |
| 8 | | IC, RCVR 330-440 MHZ, SOIC-8 | N | 1 | EA |
| 9 | | CAP, 5.6 pF 5% 50 VDC, 0603 | Y | 1 | EA |
| 10 | | CAP, 100 pF 5% 50 VDC, 0603 | Y | 1 | EA |
| 11 | | CAP, 4.7 pF 5% 50 VDC, 0603 | Y | 1 | EA |
| 12 | | CAP, 0.47 uF 10% 25 VDC, 0603 | Y | 1 | EA |
| 13 | | CAP, 0.10 uF 10% 25 VDC, 0603 | Y | 1 | EA |
| 14 | | CAP, 4.7 uF +80-20%, 10 VDC, 0805 | Y | 2 | EA |
| 15 | | INDUCTOR, 30 nH 5% 0603 | Y | 1 | EA |
| 16 | | INDUCTOR, 24 nH 5% 0603 | Y | 1 | EA |
| 17 | | FERRITE BEAD, >600 OHM @ 100 mhZ | Y | 3 | EA |
| 18 | | RES, 331R 1% 0603 | Y | 2 | EA |
| 19 | | RES, 100K 1% 0603 | Y | 1 | EA |
| 20 | | CRYSTAL, 13.419 MHZ | Y | 1 | EA |
| 21 | Power Supplies (120 VDC and 5 VDC) | | | | |
| 22 | | POWER CORD | Y | 1 | EA |
| 23 | | SWITCH, PCB MT RT ANGLE | Y | 1 | EA |
| 24 | | FUSE, 1 A 250 VAC | Y | 2 | EA |
| 25 | | FUSEHOLDER, SMT | Y | 2 | EA |
| 26 | | CAP 0.1 uF 275 V | Y | 1 | EA |
| 27 | | CAP 220 pF 2000 V | Y | 2 | EA |
| 28 | | CHOKE, COMMON MODE 10 mH | Y | 1 | EA |
| 29 | | MOV | Y | 3 | EA |
| 30 | | BRIDGE DIODE, 1.5 A 400 V SMT | Y | 1 | EA |
| 31 | ALT | BRIDGE DIODE, 1.5 A 400 V SMT | Y | 0 | EA |
| | | CAP, 4.7 uF +80-20%, 200 V | | | |
| 32 | | ELECTROLYTIC SMT | Y | 2 | EA |
| 33 | | PS, 120 VAC-5 VDC 0.6 A | N | 1 | EA |
| | | CAP, 150 uF +80-20% 10 V | | | |
| 34 | | ELECTROLYTIC SMT | Y | 1 | EA |
| 35 | | TVS, 6.8 V | Y | 1 | EA |
| 36 | | CAP, 0.10 uF 10% 25 VDC, 0603 | Y | 1 | EA |
| 37 | | RES, WW 10R 2 W | Y | 1 | EA |
| 38 | | | | | |
| 39 | CPU Section | | | | |
| 40 | | MICROCNTLR, 80 MHZ TQFP-64 | N | 1 | EA |
| 41 | | CAP, 0.10 uF 10% 25 VDC, 0603 | Y | 6 | EA |
| 42 | | SPEAKER | Y | 1 | EA |
| 43 | | IC, SPEAKER AMP | Y | 1 | EA |
| 44 | | HEADER, 10 PIN 2X5 TH | Y | 0 | EA |
| 45 | | RES 10K 5% 0603 | Y | 4 | EA |
| 46 | | | | | |
| 47 | Motor Drives | | | | |
| 48 | | HEADER, 2-P | Y | 5 | EA |
| 49 | | MOSFET, N, 200 V 0.85 A SOT-223 | ASK | 9 | EA |
| 50 | | MOSFET, P, 200 V 0.67 A SOT-223 | ASK | 8 | EA |
| 51 | | XSTR, NPN 200 V 50 mA SOT-23 | ASK | 8 | EA |
| 52 | | RES, 2.7K 5% 0603 | Y | 8 | EA |
| 53 | | RES, 1.0K 5% 0603 | Y | 9 | EA |
| 54 | | IC, QUAD AND GATE SOIC-14 | Y | 2 | EA |
| 55 | (DC CURRENT MEASURMENT CIRCUIT) | | Y | | EA |
| 56 | | RES 1.00R 1% 1 W SMT | Y | 5 | EA |
| 57 | | IC, QUAD OP AMP SOIC-14 | Y | 2 | EA |
| 58 | | RES 15.0K 1% 0603 | Y | 10 | EA |
| 59 | | RES 105K 1% 0603 | Y | 5 | EA |
| 60 | | CAP, 0.10 uF 10% 25 VDC, 0603 | Y | 5 | EA |
| 61 | (TACHOMETER) | | | | |
| 62 | | LED, IR, RT ANGLE SMT | Y | 5 | EA |
| 63 | | PHOTOTRANSISTOR, RT ANG SMT | Y | 5 | EA |
| 64 | | RES 1.0K 5% 0603 | Y | 5 | EA |
| 65 | | RES 150R 5% 0603 | Y | 5 | EA |
| 66 | | CAP, 0.10 uF 10% 25 VDC, 0603 | Y | 5 | EA |
| 67 | (AC ZERO CROSSING DETECTOR) | | | | |
| 68 | D1 | DIODE, SERIES DUAL, SOT-23 | Y | 1 | EA |
| 69 | ALT | DIODE, SERIES DUAL, SOT-23 | Y | 0 | EA |
| 70 | R1, R6 | RES, 560K 5% 0.1 W 0603 | Y | 2 | EA |
| 71 | R2-R5 | RES, 10.0K 1% 0.1 W 0603 | Y | 4 | EA |
| 72 | C1 | CAP, 0.1 uF 200 V CER SMT 1210 | Y | 0 | EA |
| 73 | ALT | CAP, 0.1 uF 250 V CER SMT 1210 | Y | 1 | EA |

TABLE 2

| | | | Qty |
|---|---|---|---|
| Item # | Part No. | Part Name | Req'd |
| 1.00.00.00 | E100.001 | 2010 Home Relief System | 1 |
| 1.10. | S100.001 | Touch-Remote Unit | 1 |
| 1.10.10 | S110.001 | Circuit Board-Carrier(Remote) | 1 |
| 1.10.10.001 | C110.001 | Re-Set I/O Button | 1 |
| 1.10.10.002 | C110.002 | Status LED's | 3 |
| 1.10.10.003 | C110.003 | Touch-Pad w/Bus&Connector | 1 |
| 1.10.10.004 | C110.004 | Terminal Connector for Touch Pad | 1 |
| 1.10.10.005 | C110.005 | Controller - IC -Remote (Incl. “Record/Play” | 1 |
| 1.10.10.006 | C110.006 | Voltage Regulator - | 1 |
| 1.10.10.007 | C110.007 | Battery Clip Terminal (1 set; 2 cells) | 1 |
| 1.10.10.008 | C110.008 | RF Transmitter | 1 |
| 1.10.10.009 | C110.009 | PCB | 1 |
| 1.10.001 | C100.001 | Upper Remote Housing | 1 |
| 1.10.002 | C100.002 | Lower Remote Housing | 1 |
| 1.10.003 | C100.003 | Battery Access Plate | 1 |
| 1.10.004 | C100.004 | Screws-Self Tapping Upr to Lwr | 3 |
| 1.20 | S200.001 | Main System Body Assy | 1 |
| 1.20.001 | C200.001 | Main Housing Base | 1 |
| 1.20.002 | C200.002 | Side Pnl LH | 1 |
| 1.20.003 | C200.003 | SidePnl RH | 1 |
| 1.20.004 | C200.004 | Motor | 4 |
| 1.20.005 | C200.005 | Screw Rod (½″ Dia; 28″ Long) | 2 |
| 1.20.006 | C200.006 | Screw Rod (½″ Dia; 25″ Long) | 2 |
| 1.20.007 | C200.007 | Bearing/Bushing | 4 |
| 1.20.008 | C200.008 | Screws - Motor to Base/Side | 12 |
| 1.20.009 | C200.009 | Cross Slide Assy | 1 |
| 1.20.010 | C200.010 | Pad assy | 1 |
| 1.20.10 | S210.001 | Circuit Board-Carrier(Main) | 1 |
| 1.20.10.001 | C210.001 | RF Receiver | 1 |
| 1.20.10.002 | C210.002 | Controller - IC - Main Body | 1 |
| 1.20.10.003 | C210.003 | Drive - Motor Controller | 4 |
| 1.20.10.004 | C210.004 | Switch - Limit | 4 |
| 1.20.10.005 | C210.005 | Voltage Regulator | 1 |
| 1.20.10.006 | C210.006 | Power Cord | 1 |
| 1.20.10.007 | C210.007 | Grommet/Fixation for Pwr Cord | 1 |
| 1.20.10.008 | C210.008 | Switch Power -AC + LED | 1 |
| 1.20.10.009 | C210.009 | Carrier Controls (Supplied by MC) | 1 |

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

What is claimed is:

1. A user-guided massage unit, comprising a housing including three-dimensional massage means for massaging in three-dimensions, said three-dimensional massage means being in electronic contact with a touch-screen interface and including translation means for translating movement on said touch-screen interface to movement of said three-dimensional massage means.

2. The user-guided massage unit of claim 1, wherein said housing further includes a membrane surface covering said three-dimensional massage means.

3. The user-guided massage unit of claim 1, wherein said three-dimensional massage means are further defined as a stylus operatively connected to an x-axis movement mechanism, a y-axis movement mechanism, and a z-axis movement mechanism.

4. The user-guided massage unit of claim 3, wherein said x- and y-axis movement mechanisms each further include linear motion means for translating rotary motion of motors to linear motion of carriages.

5. The user-guided massage unit of claim 4, wherein said linear motion means are further defined as a vertical movement carrier beam slidably connected at a proximal end and a distal end to y-axis carriages, and a horizontal movement carrier beam slidably connected at a proximal end and a distal end to x-axis carriages, said vertical movement carrier beam being slidably connected to said horizontal movement carrier beam.

6. The user-guided massage unit of claim 5, wherein said vertical movement carrier beam is slidably connected to said horizontal movement carrier beam through a housing including said stylus.

7. The user-guided massage unit of claim 3, wherein said x-, y-, and z-axis movement mechanisms are in electronic communication with said translation means.

8. The user-guided massage unit of claim 3, wherein said translation means include an algorithm for translating movement on said touch-screen interface to movement of said x-, y-, and z-axis movement mechanisms.

9. The user-guided massage unit of claim 1, wherein said translating means includes electronic receiving means for receiving electronic signals from said touch-screen interface chosen from the group consisting of wireless and hardwire signals.

10. The user-guided massage unit of claim 1, wherein said housing further includes a power source chosen from the group consisting of a battery, AC, and DC.

11. The user-guided massage unit of claim 1, wherein said three-dimensional massage means further includes elements chosen from the group consisting of a pulsing element, a heating element, and combinations thereof.

12. The user-guided massage unit of claim 1, wherein said touch-screen interface is further defined as a console including a touch-screen.

13. The user-guided massage unit of claim 12, wherein an area of said touch-screen corresponds to an area of operability of said three-dimensional massage means.

14. The user-guided massage unit of claim 1, wherein said touch-screen interface includes data conversion means for converting movement on said touch-screen interface into data, and said translation means are further defined as translating said data to movement of said three-dimensional massage means.

15. The user-guided massage unit of claim 1, wherein said touch-screen interface further includes a power source chosen from the group consisting of batteries, hardwire power from said housing, solar power, and combinations thereof.

16. The user-guided massage unit of claim 1, wherein said touch-screen interface further includes electronic transmitting means for transmitting electronic signals to said electronic receiving means chosen from the group consisting of wireless and hardwire signals.

17. The user-guided massage unit of claim 1, wherein said touch-screen interface further includes memory means for storing and selecting massage routines.

18. The user-guided massage unit of claim 17, wherein said memory means are programmable by a user.

19. The user-guided massage unit of claim 17, wherein said memory means includes pre-set massage routines.

20. The user-guided massage unit of claim 1, wherein said touch-screen interface further includes operating controls for elements chosen from the group consisting of a pulsing element, a heating element, and combinations thereof.

21. The user-guided massage unit of claim 1, wherein said touch-screen interface includes operating controls chosen from the group consisting of touch-screen controls, hard controls, and voice controls.

22. A chair including the user-guided massage unit of claim 1.

23. A method of providing a massage, including the steps of:
operating a touch-screen interface;
translating movement on the touch-screen interface to movement of three-dimensional massage means of a user-guided massage unit;
moving the three-dimensional massage means; and
providing a massage.

24. The method of claim 23, wherein said operating step is further defined as moving a user's fingertip across the touch-screen.

25. The method of claim 24, wherein said translating step is further defined as translating movement of the user's fingertip across the touch-screen to movement of a stylus in an x-, y-, and z-axis in the user-guided massage unit.

26. The method of claim 24, wherein said operating step is further defined as applying pressure to the touch-screen and said translating step is further defined as moving the three-dimensional massage means in a z-axis corresponding to how much pressure is applied to the touch-screen.

27. The method of claim 23, wherein said translating step further includes the steps of receiving data from said touch-screen interface and translating the data to movement of the three-dimensional massage means.

28. The method of claim 23, further including the step of selecting an operating mode of pulsing, heating, and combinations thereof.

29. The method of claim 23, further including the step of storing a massage routine in the touch-screen interface.

30. The method of claim 23, wherein said operating step is further defined as selecting a stored massage routine.

31. A method of storing a massage routine, including the steps of:
selecting a learning mode;
operating a touch-screen interface;
translating movement on the touch-screen interface to movement of three-dimensional massage means of a user-guided massage unit;
moving the three-dimensional massage means;
providing a massage; and
storing the massage routine.
